(19) United States
(12) Patent Application Publication
(10) Pub. No.: US 2026/0113813 A1
(43) Pub. Date: Apr. 23, 2026

(54) GLASS-CERAMIC ARTICLE AND METHOD FOR MANUFACTURING SUCH AN ARTICLE

(71) Applicant: EUROKERA S.N.C., CHATEAU THIERRY (FR)

(72) Inventors: Erwann LUAIS, CHATEAU THIERRY (FR); Rubens MASSE, CHATEAU THIERRY (FR); Jean-Paul HALLUIN, CHATEAU THIERRY (FR); Jérôme FRAYRET, DUPPIGHEIM (FR)

(21) Appl. No.: 19/118,237

(22) PCT Filed: Oct. 5, 2023
(86) PCT No.: PCT/EP2023/077526

§ 371 Date: Apr. 3, 2025

(30) Foreign Application Priority Data
Oct. 5, 2022 (FR) FR2210176

(51) Int. Cl. H05B 3/74; C03B 32/02; C03C 15/00; C03C 19/00

(52) U.S. Cl. CPC H05B 3/74; C03B 32/02; C03C 15/00; C03C 19/00

(57) ABSTRACT

A planar glass-ceramic article has a first main surface, a second main surface, and an edge. At least one of the two main surfaces of the glass-ceramic article has an intrinsic texture, the hybrid root-mean-square roughness RMS of which is between 4.4° and 11°.

### TECHNICAL FIELD

The invention relates to a planar glass-ceramic article comprising a textured surface which has anti-scratch, anti-soiling properties, as well as an aesthetic surface appearance suitable for domestic use. It also relates to a method for manufacturing such a glass-ceramic article.

### TECHNICAL BACKGROUND

A glass-ceramic material is a composite material comprising an amorphous phase wherein crystalline phases or crystals are dispersed. It is generally obtained by heat treatment of a glass suitable for forming a glass-ceramic, known as “mother glass”, in order to crystallize crystals in its volume in a controlled manner. This treatment, whereby glass partially crystallizes, is known as “ceramization treatment” or simply “ceramization”. The final physico-chemical properties of glass-ceramics depend on the composition of the mother glass and the ceramization treatment.

Glass-ceramics are popular in numerous fields for their aesthetic qualities and their physical/chemical properties, in particular their low coefficient of thermal expansion and their resistance to thermal shocks. They are particularly used in kitchen equipment, in particular in the form of a cooktop, for example as a cooking surface in cooking devices, glazed oven walls, and work surfaces in the working surfaces, tables or furniture for the preparation of foods. In these applications, glass-ceramics are generally based on lithium aluminosilicate.

Depending on their use, glass-ceramic articles may be fitted with a number of accessories, such as controls, sensors and displays, which enable interaction between the user and the devices wherein these articles are incorporated.

By way of example, they may be fitted with controls, such as touch-sensitive or optical buttons, for operating and controlling various electrical and/or electronic devices, such as heating and/or lighting means. They may also comprise displays, in particular luminous displays, for the projection, particularly in transmission, of cognitive luminous patterns (e.g. icons or numbers) representing the values of certain operating parameters of these devices (e.g. the heating power of a heating device), or relating to the physico-chemical state of the article (e.g. signaling a hot zone).

They may also be equipped with optical and/or thermal sensors to detect, for example, elements on their surface such as spilled liquid, or to measure the surface temperature of the article, and to warn the user by audible or visual signals via a display zone.

Interactions, particularly tactile ones, between the surface of the glass-ceramic article and the user, and the handling of liquid or solid food substances and mechanical preparation instruments (e.g. knife blades), result in the appearance of various unsightly marks at points of contact with the surface, particularly fingerprints. They may also cause soiling, such as the remains of dried or burnt foodstuffs on the surface of the article, or scratches.

These marks and soiling may lead to repeated cleaning by the user using abrasive products, which in turn may cause further scratches. These problems are particularly acute on glass-ceramic products with dark, matte or glossy work surfaces.

In order to prevent fingerprints and soiling and to limit the appearance or visibility of scratches, it is known to use various organic or inorganic coatings, textured or not, with hydrophobic or oleophobic properties. It is also known to alter the surface of glass-ceramics in order to obtain such properties.

JP 2007170754 NIPPON ELECTRIC GLASS CO [JP] dated Jul. 5, 2007 describes a glass-ceramic article comprising a work surface with a roughness of between 0.1 μm and 20 μm to impart light-scattering properties and a milky-white appearance. This article is obtained using a combination of mechanical and chemical surface treatments.

WO 2011/137144 A1 CORNING INC [US] dated Nov. 3, 2011 describes a method for manufacturing a glass-ceramic article using etching to form a rough surface with an arithmetic roughness value of between 100 nm and 300 nm. The resulting roughness provides an anti-reflective effect.

WO 2013/190230 A1 EUROKERA [FR] dated Dec. 27, 2013 describes a glass-ceramic article comprising a surface provided with a textured layer, in particular a sol-gel layer. The texture is formed by regular patterns, in particular geometric patterns, whose height is between 2 and 100 μm.

WO 2014/070869 A1 CORNING INC [US] dated Sep. 9, 2013 describes a method of manufacturing a glass-ceramic article using etching so as to modify the surface of the article to a depth of between 0.01 μm and 20 μm. The resulting roughness reduces gloss.

WO 2016/138051 A1 CORNING INC [US] dated Sep. 1, 2016 describes a method of manufacturing a glass-ceramic article using two successive chemical etchings so as to form a surface roughness whose average distance between the features of the rough pattern is between 0.5 μm and 25 μm, and their density is between 9,000 and 25,000 features per mm². Chemical etching is carried out using hydrofluoric acid-based acid solutions.

WO 2018/093844 A1 CORNING INC [US] dated May 24, 2018 describes a method for manufacturing a glass-ceramic article comprising a non-planar surface with an arithmetic roughness value of between 10 and 2000 nm. The method comprises a step of etching the surface with a hydrofluoric acid solution. The surface roughness provides aesthetic effects, reduced gloss, anti-reflective effect and improved haptic feel.

WO 2021/121846 A1 EUROKERA [FR] dated Jun. 24, 2021 describes a method for manufacturing a glass-ceramic article using etching. The surface of the glass-ceramic article has an arithmetic roughness value of between 2 μm and 7 μm.

### SUMMARY OF THE INVENTION

### Technical Problem

There is still a need to improve the aesthetic appearance and mechanical scratch resistance of glass-ceramic surfaces, particularly for dark or black glass-ceramic items.

Such an article must have optical and physico-chemical surface properties compatible with the applications for which it is intended, in particular applications in cooking appliances and/or as a worktop surface. More specifically, it must have anti-scratch, grease-repellent, dirt-repellent and anti-light scattering properties. It must also have an aesthetic surface appearance suitable for domestic use.

### Solution to the Technical Problem

According to a first aspect of the invention, there is provided a glass-ceramic article comprising a first main surface, a second main surface and an edge, characterized in that all or part of at least one of the two main surfaces has an intrinsic texture whose hybrid root-mean-square roughness Rdq is between 4.4° and 11°. Other advantageous embodiments are described below.

In accordance with the invention, the rough texturing is intrinsic to the surface of the glass-ceramic article, that is, the surface roughness comes from the surface itself without any added surface coating.

According to a second aspect of the invention, a method is provided for manufacturing a glass-ceramic article according to the first aspect of the invention.

According to a third aspect of the invention, a cooking device is provided comprising a glass-ceramic cooktop formed by a glass-ceramic article according to the first aspect of the invention.

According to a fourth aspect of the invention, a glass-ceramic article according to the first aspect of the invention is used as all or part of a worktop for food preparation.

### Advantages of the Invention

A remarkable advantage of the invention is that, when applied to dark or black colored glass-ceramic articles, it enables a surface gloss level at 60° of much less than 30, or even less than 25, and a brightness level of less than 23 to be achieved. The article then presents a dark matte appearance, meeting the aesthetic requirements for domestic applications.

In some advantageous embodiments, the haze level is less than 50%, or even 30%. The visibility of light patterns transmitted by luminous displays on or through the surface of the glass-ceramic article remains clear for improved visual comfort when said article is used in a cooking device.

Another advantage is that, in some embodiments, the particular roughness of the glass-ceramic article, which is intrinsic or inherent to the surface of the glass-ceramic article, does not alter the thermal and mechanical properties of said surface. It allows easy removal of any soiling and is more resistant to metal abrasion.

### BRIEF DESCRIPTION OF THE DRAWINGS

FIG. 1 shows the evolution of the surface gloss at 60° of examples of glass-ceramic articles conforming to the invention and of counter-examples based on their hybrid root-mean-square roughness.

FIG. 2 shows the evolution of the surface lightness of examples of glass-ceramic articles conforming to the invention and of counter-examples based on their hybrid root-mean-square roughness.

FIG. 3 shows the evolution of the surface haze level of examples of glass-ceramic articles conforming to the invention and of counter-examples based on their hybrid root-mean-square roughness.

FIG. 4 shows the evolution of the degree of surface scratch visibility of examples of glass-ceramic articles conforming to the invention and of counter-examples based on their hybrid root-mean-square roughness and their average spacing roughness.

FIG. 5 shows the evolution of the degree of visibility of metallic rubbing marks of examples of glass-ceramic articles conforming to the invention and of counter-examples based on their average spacing roughness.

FIG. 6 shows the evolution of the anti-adhesion index for dirt on the surface of examples of glass-ceramic articles conforming to the invention and of counter-examples based on their hybrid root-mean-square roughness.

FIG. 7 shows the evolution of the degree of visibility of fingernail scratches on the surface of examples of glass-ceramic articles conforming to the invention and of counter-examples based on their surface skewness

### DETAILED DESCRIPTION OF EMBODIMENTS

In the context of the invention, reference is made to the following definitions and conventions.

Hybrid root-mean-square roughness, denoted Rdq, means the root mean square of the local slopes of the surface roughness profile over the sampling length, as defined in section 4.4.1 of ISO 4287. The hybrid root-mean-square roughness, Rdq, is a dimensionless number. It can equally be expressed in units of angle, degrees or radians, using the usual trigonometric relations in slope calculation, in particular the arctan function. For the purposes of this invention, it is expressed in degrees.

Mean spacing roughness, denoted Rsm, refers to the average of the widths of the surface roughness profile elements in the sampling length, as defined in section 4.3.1 of ISO 4287. The width of a profile element is understood to be the length of the x-axis intersected by the profile element, that is, projection or recess, as defined in section 3.2.12 of ISO 4287. Values are expressed in millimeters.

Skewness, denoted Rsk, refers to the quotient of the mean of the cubes of height values by the cube of maximum protruding heights in the sampling length, as defined in section 4.2.3 of ISO 4287.

Intrinsic or inherent texturing on the surface of a glass-ceramic article refers to the texturing of the glass-ceramic material of the article itself, without any surface coating.

A glass-ceramic article is a composite material, preferably aluminosilicate-based, in particular lithium silicate-based, comprising an amorphous phase wherein crystalline phases or crystals are dispersed. It is obtained by heat treatment of a glass suitable for forming a glass-ceramic, known as “mother glass”, in order to crystallize crystals in its volume in a controlled manner.

“Light transmission,” TL, is understood to mean the light transmission, denoted TL, as defined and measured and/or calculated in the standard EN 410:1998.

Color deviation, ΔE*, lightness or brightness, L*, and colorimetric coordinates a* and b* refer to color deviation, ΔE*, lightness or brightness, L*, and colorimetric coordinates a* and b* as defined in ISO/CIE 11664-4:2019.

“60° gloss” refers to the specular gloss at 60° as described and measured in EN ISO 2813:1999.

“Haze” refers to haze as defined and measured in ISO 14782:1999.

According to a first aspect of the invention, there is provided a planar glass-ceramic article comprising a first main surface, a second main surface and an edge, characterized in that all or part of at least one of the two main surfaces has an intrinsic texture whose hybrid root-mean-square roughness Rdq is between 4.4° and 11°.

In accordance with the first aspect of the invention, the glass-ceramic article is planar. It may comprise two substantially parallel planar main surfaces and four lateral surfaces substantially perpendicular to the two main faces, and may take the form of a glass-ceramic cooktop.

The “mother glass” for the glass-ceramic article may be of any suitable type. According to a preferred embodiment, the mother glass is based on lithium aluminosilicate comprising the following constituents within the weight limits defined in table 1 below and expressed as percentages by weight of the glass:

TABLE 1

| | |
|---|---|
| SiO2 | 58-75% |
| Al2O3 | 16-25% |
| Li2O | 2-4.5% |
| Na2O | 0-2% |
| K2O | 0-2% |
| CaO | 0-4% |
| MgO | 0-5% |
| BaO | 0-5% |
| ZnO | 0-5% |
| SrO | 0-5% |
| TiO2 | 1-6% |
| ZrO2 | 0-3% |
| P2O5 | 0-6% |
| B2O3 | 0-2% |
| Fe2O3 | 0-2% |
| Cr2O3 | 0-2% |
| CoO | 0-2% |

As mentioned above, a remarkable advantage of the first aspect of the invention is that it enables a glass-ceramic article to be obtained that meets aesthetic requirements for domestic applications such as, for example, a cooktop or a worktop. In particular, in the case of an initially black or dark glass-ceramic article, the surface gloss level at 60° may be well below 30, or even below 25, and the lightness level may be below 23.

According to some advantageous embodiments, the hybrid root-mean-square roughness Rdq may be between 5.5° and 9°. It has been found that, when the roughness Rdq is within this range, the visibility of light patterns transmitted by luminous displays on or through the surface of the glass-ceramic article remains clear for improved visual comfort. This results in a haze level of less than 50%, or even 30%.

In other particular embodiments, the intrinsic texture may further have a mean spacing roughness Rsm greater than 0.2 mm, preferably greater than 0.27 mm. This type of texturing increases the mechanical strength of the surface, thereby reducing the visibility of scratches.

Glass-ceramic articles are commonly used as a cooking or working surface in kitchen equipment. In this type of application, when metal utensils such as pots and pans are moved over their surfaces, these surface may be particularly stressed. These displacements may in particular take the form of metallic friction.

According to certain embodiments, the mean spacing roughness Rsm may be much greater than 0.27 mm, in particular greater than 0.4 mm. The glass-ceramic article may then very advantageously present a high resistance to metallic friction, in particular to metallic friction linked to the movement of pans, as well as a chemical and mechanical durability advantageous for repeated exposure to food products and heating cycles.

In addition to exposure to utensils and food products, the surfaces of glass-ceramic articles incorporated into kitchen equipment may also be subjected to fingernail rubbing, particularly when users' hands move over integrated control panels. According to some embodiments, the intrinsic texture may then have a skewness, Rsk, of less than −0.2, preferably less than −0.3, most preferably less than −0.5. Surprisingly, this reduced the visibility of traces formed by fingernail movements on the surface of the glass-ceramic article.

The effects and advantages of the invention are particularly pronounced when the glass-ceramic article is low-transmissive, low-scattering and dark in color (defined by brightness L*), especially black or dark brown. Preferably, the glass-ceramic article may remain suitable for the transmissive display of luminous zones comprising cognitive luminous patterns representative of values of certain operating parameters of associated electrical and/or electronic devices, or relating to a physico-chemical state of the article, while masking the underlying elements.

In this sense, in a particular embodiment of the invention, the glass-ceramic article has a brightness L* less than or equal to 25, preferably less than or equal to 20. It may also have an initial brightness, that is, when it has no surface texture, L* of 25 or less, preferably 20 or less.

A dark-colored glass-ceramic article may initially, that is, when it has no surface texture, have an opacity factor of less than 100, and advantageously greater than 93, in order in particular to enable said display in transmission by underlying sources in one embodiment of the invention or a projection display.

The opacity factor is determined by the formula f=100−ΔE* where ΔE* is the color deviation. The color deviation ΔE* may be evaluated by measuring, in reflection, the variations in lightness L* and colorimetric parameters a* and b* of the upper surface of the article when it is placed on an opaque black background and then when it is placed on an opaque white background, in the CIELAB colorimetric system. The color deviation ΔE* may be calculated according to the following formula, ΔE*=((LN*−LB*)²+(aN*−aB*)²+(bN*−bB*)²)^{1/2}, LB*, aB*,bB* being the lightness and colorimetric coordinates of the first measurement on a white background and LN*, aN*, bN* being those of the second measurement on a black background.

A black glass-ceramic article may initially present, that is, when it is devoid of surface texture, a brightness L* of less than 10, a haze of less than 30%, and a light transmission TL of less than 10% under illuminant D65.

Preferably, the dark-colored glass-ceramic article initially has, that is, when it is devoid of surface texture, an a* parameter value of between −0.2 and 1.6 and a b* parameter value of between −1 and 0.6.

A glass-ceramic article according to the first aspect of the invention enables light patterns transmitted by luminous displays on or through the rough surface to remain sharp for improved viewing comfort for the user.

According to some preferred embodiments, the 60° gloss of the glass-ceramic article may be less than 20, preferably less than 10. These gloss levels are particularly advantageous for the aesthetic appearance of the glass-ceramic surface, especially when the latter is dark or black in color.

Thus, according to some embodiments, the glass-ceramic article may further comprise at least one light source for luminous display by projection or transmission on the surface then forming the screen. The display may, for example, be a luminous LED display, in particular a seven-segment display for displaying alphanumeric characters.

According to a second aspect of the invention, there is provided a method for manufacturing a glass-ceramic article comprising the following steps:
a ceramization heat treatment of a glass capable of forming a glass-ceramic, and
a chemical treatment of a surface of said glass before and/or after said ceramization heat treatment,
   the chemical surface treatment being carried out in such a way that, after heat treatment, the hybrid root-mean-square roughness value Rdq is between 4.4 and 11°, preferably between 5.5 and 9°.

According to some advantageous embodiments, the method may further comprise a mechanical surface treatment step by sandblasting, prior to chemical surface treatment.

The chemical surface treatment may be carried out before and/or after the ceramization heat treatment. According to a preferred embodiment, the chemical surface treatment is carried out prior to the ceramization heat treatment. The anti-scratch, grease-repellent, dirt-repellent and anti-light-scattering properties were found to be further enhanced.

According to the invention, roughness is achieved by chemical surface treatment of the mother glass of the glass-ceramic article, that is, prior to the ceramization heat treatment of the mother glass to form the glass-ceramic article. The roughness values are therefore those of the roughened surface of the glass-ceramic article after the ceramization treatment.

The glass suitable for forming a glass-ceramic may preferably be aluminosilicate-based, especially lithium aluminosilicate.

The type of chemical solution used for treatment, the treatment temperature and its duration depend on the chemical composition of the material forming the mother glass of the glass-ceramic article.

The method according to the second aspect of the invention enables the glass-ceramic article to be roughened over its entire work surface. It is also possible to roughen only part of the work surface of the glass-ceramic article. This feature may be achieved, for example, by applying protective masks to the surface of the mother glass during chemical and/or mechanical surface treatment, so as to create resists on certain areas of said surface.

In some embodiments, the chemical surface treatment may be chemical etching with a hydrofluoric acid-based solution. These embodiments are particularly advantageous for aluminosilicate-based glass-ceramic articles, especially lithium aluminosilicate.

According to some preferred embodiments, the chemical treatment may further comprise a preliminary step, known as a surface activation step, prior to the aforementioned chemical etching. This activation step may consist in chemical etching using an acid solution comprising hydrochloric acid and hydrofluoric acid at room temperature for at least two minutes.

The hydrofluoric acid titer by weight of the acid solution may advantageously be between 1% and 70% by weight. Generally speaking, if the mass titer is less than 1%, the time required for chemical surface treatment is rather long and not very advantageous for industrial applications. If mass titer is higher than 20%, chemical surface treatment may be too rapid and difficult to control. The temperature of the solution is preferably below 40° C., or even 30° C., to prevent the chemical surface treatment from being too rapid and difficult to control.

According to some advantageous embodiments, the hydrofluoric acid solution comprises sodium fluoride, potassium fluoride, ammonium fluoride, barium sulfate, silicic acid, hexafluorosilicic acid, hydrochloric acid and/or sulfuric acid, alone or in combination.

According to a third aspect of the invention, a cooking device is provided comprising a glass-ceramic cooktop formed by a glass-ceramic article according to any one of the embodiments of the first aspect of the invention.

Examples of heating elements for a cooking device may be radiant or halogen hearths or induction heating elements.

According to a fourth aspect of the invention, a glass-ceramic article according to any one of the embodiments of the first aspect of the invention may be used as all or part of a worktop for food preparation. The worktop may, for example, be part of a piece of kitchen furniture or a surface element of a cooking device, said surface element having the function of enabling food preparation.

### EXAMPLES

The following examples and counter-examples are based on mother glasses for glass-ceramic cooktops as described in EP 0 437 228 A1 CORNING FRANCE [FR] dated Jul. 17, 1991 and/or WO 2012/156444 A1 EUROKERA [FR] dated Nov. 22, 2012, respectively marketed under the brand name KeraBlack Plus®. The thickness of the cooktops is from 4 to 6 mm.

The roughnesses were obtained by mechanical surface treatment of the mother glasses using sandblasting and/or chemical surface treatment. These two treatments were carried out before the ceramization heat treatment. When mechanical and chemical treatments are used, the two treatments are performed in succession, that is, mechanical treatment is performed before chemical treatment.

The mechanical sandblasting treatment was carried out according to the parameters described in Table 2.

TABLE 2

| Nature of abrasive grains | Silica, garnet or corundum | |
|---|---|---|
| Grain size | 150 ≤ D90 ≤ 300 μm | |
| | 100 ≤ D50 ≤ 200 μm | |
| Grain flow rate | 0.5-10 | g/s |
| Grain projection speed | 1-50 | m/s |

| | |
|---|---|
| Pressure | 0.5-5 bar, preferably |
| | between 2 bar and 4 bar |
| Incident angle | 45-90° |

Chemical surface treatment was carried out using a hydrofluoric acid-based solution whose constituents are described in Table 3.

TABLE 3

| | Concentration | |
|---|---|---|
| NH₄F, HF | 0-9 | mol/L |
| NaF, HF | 0-0.065 | mol/L |
| KF, HF | 0-0.013 | mol/L |
| HF | 0.24-35 | mol/L |
| HCl | 0-12 | mol/L |
| H₂SO₄ | 0-10 | mol/L |
| H2SiF6 | 0-0.12 | mol/L |
| SiO2 | 0-0.12 | mol/L |
| BaSO4 | 0-50 | g/L |

When roughness is obtained by mechanical surface treatment followed by chemical surface treatment, the acid solution comprises at least one of the constituents listed in Table 2. When chemical treatment alone is used, the acid solution may advantageously comprise at least two constituents listed in Table 2, one of which is selected from NH4F, HF; NaF, HF and KF, HF.

To obtain different roughness values, the plate surfaces were subjected to hydrofluoric acid solutions of different pH values, varying the proportions of their constituents within the limits of Table 3, and heating them to different temperatures between 20° C. and 50° C. Cooktop surfaces were exposed for durations ranging from 1 min to 90 min.

For illustrative purposes, the conditions used to manufacture some examples, E1-E5, and some counter-examples, CE1-CE4, are shown in Table 4 and Table 5, respectively.

TABLE 4

| | | | | | |
|---|---|---|---|---|---|
| E1 | E2 | E3 | E4 | E5 | E6 |

Acid chemical treatment solution

| | | | | | | |
|---|---|---|---|---|---|---|
| HF (mol/L) | 0.5 | 0.5 | 7.5 | 15 | 15 | 17.5 |
| NH4F, HF (mol/L) | 7 | 6.1 | 8.8 | 0 | 0 | 0 |
| H2SiF6 (mol/L) | 0.06 | 0 | 0.03 | 0.03 | 0.03 | 0.03 |
| BaSO4 | yes | no | yes | no | yes | no |
| Temperature (° C.) | 20 | 20 | 40 | 50 | 50 | 50 |
| Time (min) | 10 | 60 | 10 | 20 | 20 | 30 |

Chemical activation solution

| | | | | | | |
|---|---|---|---|---|---|---|
| HCl (mol/L) | | | 0.5 | 0.5 | 0.5 | 0.5 |
| HF (mol/L) | | | 0.05 | 0.05 | 0.05 | 0.05 |
| Time (min) | | | 2 | 2 | 2 | 2 |
| Temperature (° C.) | Ambient | Ambient | Ambient | Ambient | Ambient | Ambient |

Mechanical treatment

| | | | |
|---|---|---|---|
| Nature of | Garnet | Garnet | Garnet |
| abrasive grains | 97-98% | 97-98% | 97-98% |
| Grain size (μm) | D90 = 264 | D90 = 264 | D90 = 264 |
| | D50 = 185 | D50 = 185 | D50 = 185 |
| Pressure (bar) | 2 | 2 | 2 |

TABLE 5

| | | | |
|---|---|---|---|
| CE1 | CE2 | CE3 | CE4 |

Acid chemical treatment solution

| | | | | |
|---|---|---|---|---|
| HF (mol/L) | 1.5 | 7.5 | 10 | 12.5 |
| NH4F, HF (mol/L) | 5.3 | 8.8 | 0 | 0 |
| H2SiF6 (mol/L) | 0.06 | 0.03 | 0.03 | 0.03 |
| BaSO4 | no | no | no | no |
| Temperature (° C.) | 20 | 50 | 50 | 50 |
| Time (min) | 20 | 30 | 20 | 20 |

Chemical activation solution

| | | | | |
|---|---|---|---|---|
| HCl (mol/L) | | 0.5 | 0.5 | 0.5 |
| HF (mol/L) | | 0.05 | 0.05 | 0.05 |
| Time (min) | | 2 | 2 | 2 |
| Temperature (° C.) | Ambient | Ambient | Ambient | Ambient |

Mechanical treatment

| | | | |
|---|---|---|---|
| Nature of | Garnet | Garnet | Garnet |
| abrasive grains | 97-98% | 97-98% | 97-98% |
| Grain size (μm) | D90 = 264 | D90 = 264 | D90 = 264 |
| | D50 = 185 | D50 = 185 | D50 = 185 |
| Pressure (bar) | 2 | 2 | 2 |

The values of the various roughness parameters, Rdq, Rsm and Rsk, were measured using a Mitutoyo SJ401 mechanical probe and evaluated in accordance with ISO 4287 over an evaluation length of 4 mm to 12.5 mm, equipped with a “12AAC731” type stylus.

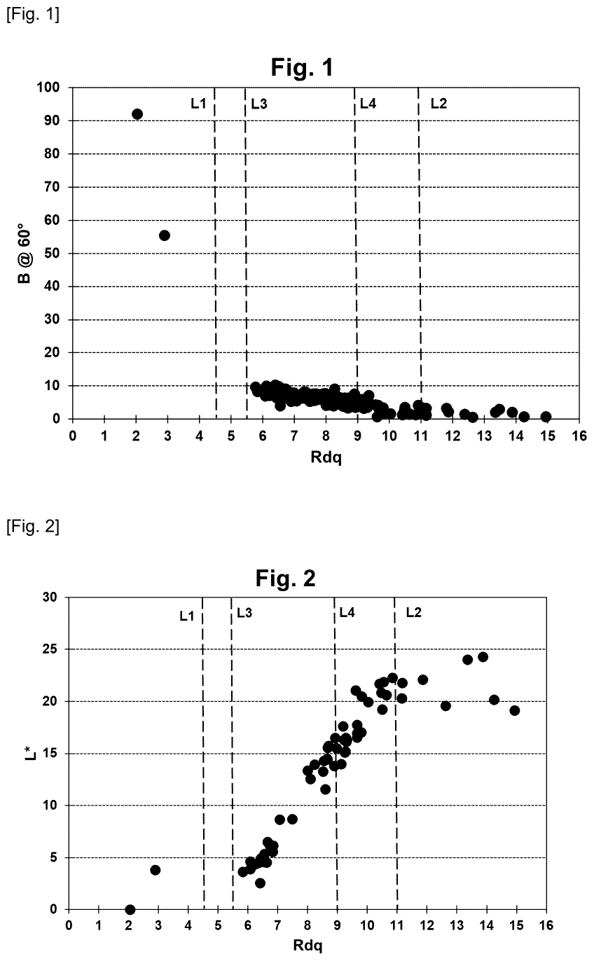

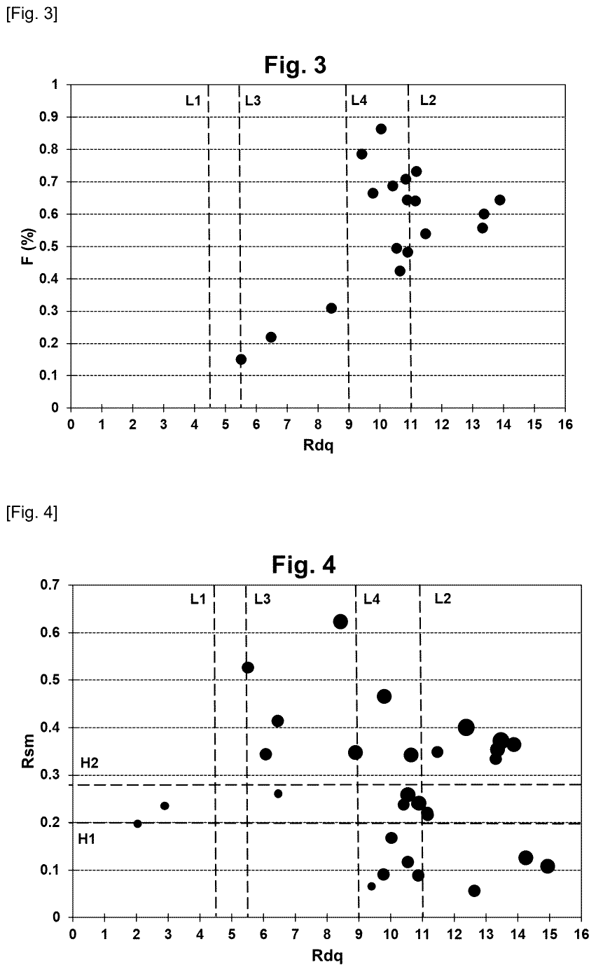

The 60° brightness, L* clarity and haze level of the examples and counter-examples were measured and/or assessed in accordance with EN ISO 2813:1999, ISO/CIE 11664-4:2019 and ISO 14782:1999, respectively. The results are shown in FIG. 1, FIG. 2 and FIG. 3, respectively. Table 6 and Table 7 show the results of examples E1-E6 and counter-examples CE1-CE4.

TABLE 6

| | E1 | E2 | E3 | E4 | E5 | E6 |
|---|---|---|---|---|---|---|
| Rsm (mm) | 0.066 | 0.117 | 0.091 | 0.451 | 0.413 | 0.608 |
| Rdq (°) | 9.52 | 10.42 | 9.77 | 8.73 | 9.84 | 4.36 |
| Rsk | 0.97 | −0.14 | −0.31 | −0.32 | −0.26 | −0.39 |
| L* | 21.1 | 21.9 | 20.5 | 14.6 | 16.2 | 2.2 |
| 60° gloss | 0.8 | 2.1 | 1.9 | 4.7 | 4 | 12.1 |

TABLE 7

| | CE1 | CE2 | CE3 | CE4 |
|---|---|---|---|---|
| Rsm (mm) | 0.126 | 0.354 | 0.395 | 0.399 |
| Rdq (°) | 13.97 | 16.55 | 17.32 | 14.74 |
| Rsk | −0.11 | −0.19 | −0.35 | −0.14 |
| L* | 20.2 | 20.0 | 23.5 | 22.7 |
| 60° gloss | 0.8 | 0.6 | 1.7 | 2.6 |

In FIG. 1, examples in accordance with the invention are located between the vertical lines L1 (Rdq=4.4°) and L2 (Rdq=11°), and, in some advantageous embodiments, between the vertical lines L3 (Rdq=5.5°) and L4 (Rdq=9°). The counter-examples are located outside the area delimited by the vertical lines L1 and L2. The examples according to the invention all have a gloss, B, at 60° of less than 20.

In FIG. 2, examples in accordance with the invention are located between the vertical lines L1 and L2, and, in some advantageous embodiments, between the vertical lines L3 and L4. The counter-examples are located outside the area delimited by the vertical lines L1 and L2. The examples conforming to the invention all have a lightness or brightness, L*, of less than 25, or even less than 20 for the examples located between the vertical lines L3 and L4.

In FIG. 3, the examples the examples in accordance with the invention are located between the vertical lines L1 and L2, and, in some advantageous embodiments, between the vertical lines L3 and L4. The counter-examples are located outside the area delimited by the vertical lines L1 and L2. The examples conforming to said embodiments of the invention all have a level of haze F of less than 50%, or even less than 30% for the examples located between the vertical lines L3 and L4.

The examples and counter-examples were also subjected to various tests to assess their anti-scratch and dirt-repellent properties.

The anti-scratch property was evaluated using the following protocol. The rough surface of the article is placed under a P240 silicon carbide abrasive disc at a pressure of about 5 N/cm². The disc is then moved once in this state over a distance of about 4 to 5 cm. The rough surface of the glass-ceramic article is then placed under white lighting of 300-400 lux, and observed at an angle of about 60°. The visibility of scratches is rated according to the following scale of degrees:
1: highly visible scratches;
2: acceptably visible scratches;
3: faint scratches;
4: no visible scratches.

The results obtained for the examples and counter-examples are shown in FIG. 4. This graph depicts, for each glass-ceramic article, the evolution of the average value of the degree, d, of scratch visibility based on the value of the hybrid root-mean-square roughness, Rdq, on the abscissa, and of the mean spacing roughness, Rsm, on the ordinate. The degree of visibility, d, is represented by the size of the figures.

In FIG. 4, examples in accordance with the invention are located between the vertical lines L1 and L2, and above the horizontal line H1 (Rsm=0.2) or H2 (Rsm=0.27). The examples conform to certain advantageous embodiments between the vertical lines L3 and L4, and above the horizontal line H1 (Rsm=0.2) or H2 (Rsm=0.27). The counter-examples are located outside the area bounded by the vertical lines L1 and L2, and below or above the horizontal line H1.

In the area between the vertical lines L1 and L2, and above the horizontal line H1 (Rsm=0.2), 90% of the examples conforming to the invention have a degree of visibility of at least 2, that is, the visibility of the scratches is at least acceptable, or they are not visible at all. Above the horizontal line H2 (Rsm=0.27), all samples have a visibility level of at least 2, and over 50% greater than 3.

The resistance to metallic friction of the examples and counter-examples was evaluated according to the following protocol. First, the surface of the enameled area of the glass-ceramic cooktop is successively rubbed back and forth with several metal elements such as coins and metal and/or enameled pans. The surface is then cleaned using a range of commercially available detergents specially designed for cooktop cleaning, such as those marketed under the VitroClen® or CIF® brand names. Degradation of the enameled surface is assessed visually on a scale of 0 to 20, with 0 corresponding to total surface degradation and 20 to no degradation at all. In other words, the higher the degree, the more resistant the surface is to metallic friction.

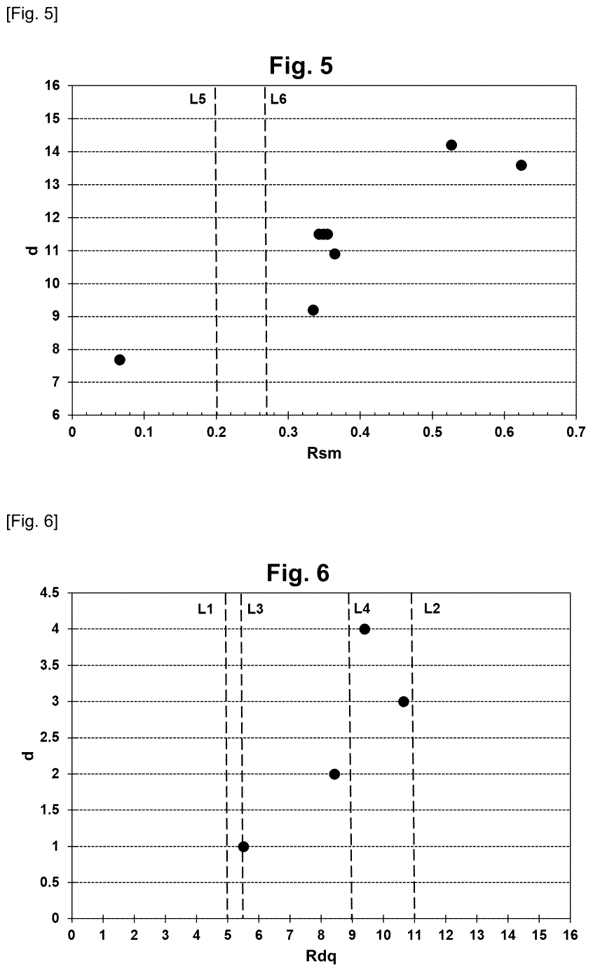

The results obtained for the examples and counter-examples are shown in FIG. 5. This graph depicts, for each glass-ceramic article, the evolution of the average value of the degree, d, of metallic friction visibility based on the mean spacing roughness, Rsm.

In FIG. 5, examples conforming to the invention are located to the right of vertical line L5 (Rsm=0.2) or, in some advantageous embodiments, to the right of vertical line L6 (Rsm=0.27). The examples in accordance with the invention have a degree of visibility of metallic friction greater than 9, which may be considered acceptable. Preferably, the average spacing roughness may be selected to be greater than 0.4 in order to achieve a degree of visibility greater than 12 for applications requiring a certain level of resistance to metallic friction.

The dirt-repellent property was evaluated using the following protocol. The glass-ceramic article is first inserted into a cooking appliance wherein its work surface serves as the cooking surface. It is then subjected to a cycle of four successive soiling-cleaning operations, each comprising a soiling step and a cleaning step. This cycle of four operations is repeated eight times. At the end of these eight repetitions, the surface of the article is manually cleaned with a sponge impregnated with a commercially available detergent specially designed for cleaning cooktops, for example the detergent marketed under the brand name VitroClen® or CIF®.

In the first operation, the soiling step consists in pouring rice cooking water over the glass-ceramic article, then covering it with a pan filled with water whose temperature is raised to 100° C. for two minutes. The pan is then left to cool naturally to room temperature. Once room temperature has been reached, the temperature is raised again to 100° C. for two minutes, then the pan is left to cool naturally. At the end of the soiling stage, once the water in the pan has cooled to room temperature, the article is cleaned using a scraper sponge impregnated with water and detergent (washing-up liquid). Cleaning is repeated four times.

In the second operation, the soiling step consists in pouring edible oil onto the surface of the glass-ceramic article, then covering it with a pan filled with edible oil, the temperature of which is raised to at least 200° C. for three minutes. The pan is then left to cool naturally to room temperature. At the end of the soiling stage, once the water in the pan has cooled to room temperature, the article is cleaned using a scraper sponge impregnated with water and detergent (washing-up liquid).

In the third operation, the soiling step consists in pouring tomato paste onto the surface of the glass-ceramic article, then covering it with a pan filled with water, the temperature of which is raised to at least 100° C. for two minutes. The pan is then left to cool naturally to room temperature. At the end of the soiling stage, once the water in the pan has cooled to room temperature, the article is cleaned using a scraper sponge impregnated with water and detergent (washing-up liquid).

In the fourth operation, the soiling step consists in pouring milk onto the surface of the glass-ceramic article, then covering it with a pan filled with water, the temperature of which is raised to at least 100° C. for two minutes. The pan is then left to cool naturally to room temperature. At the end of the soiling stage, once the water in the pan has cooled to room temperature, the article is cleaned using a scraper sponge impregnated with water and detergent (washing-up liquid).

The degree of soiling is assessed on a scale of 1 to 4 according to the surface's suitability for cleaning. Grade 0 corresponds to a completely cleanable surface; little or no residue remains on the surface after cleaning. Grade 4 corresponds to a non-cleanable surface: traces remain after cleaning.

The results obtained for the examples and counter-examples are shown in FIG. 6. This graph depicts, for each glass-ceramic article, the evolution of the average value of the degree, d, of metallic friction visibility based on the hybrid root-mean-square roughness, Rdq.

In FIG. 6, the examples according to some advantageous embodiments are shown between vertical lines L3 and L4. According to these advantageous embodiments, the conforming examples have a degree of soiling strictly below 3, which is acceptable for applications in domestic kitchen equipment, such as cooking appliances or worktops.

The nail-scratch resistance of the examples and counter-examples was evaluated according to the following protocol. A fingernail is rubbed over the surface of the glass-ceramic article. The surface of the glass-ceramic article is then placed under white lighting of 300-400 lux, and observed at an angle of about 60°. The visibility of scratches is rated according to the following scale of degrees:
1: highly visible scratches;
0.66: visible scratches;
0.33: faint scratches;
0: no visible scratches.

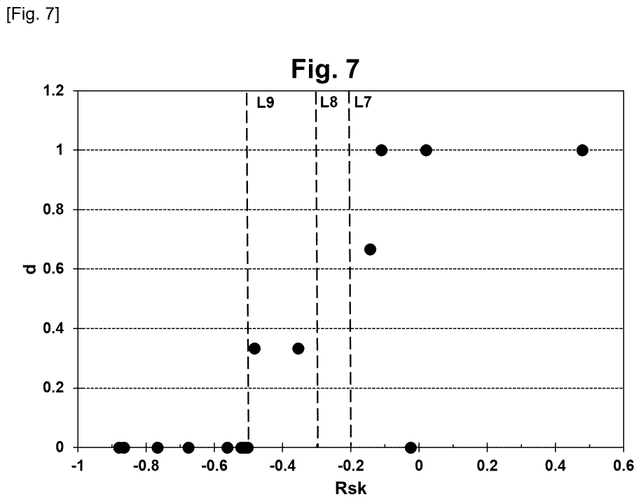

The results obtained for the examples and counter-examples are shown in FIG. 7. This graph depicts, for each glass-ceramic article, the evolution of the average value of the degree, d, of scratch visibility based on the skewness, Rsk.

In FIG. 7, examples conforming to the invention are located to the left of vertical line L7 (Rsk=−0.2) or, in some advantageous embodiments, to the left of vertical line L8 (Rsk=−0.3) or L9 (Rsk=−0.5). The counter-examples are located to the right of vertical line L7.

Nail scratches on examples conforming to the invention (Rsk<−0.2) are barely visible, or even invisible when the Rsk is less than −0.5.

These examples and counter-examples clearly show that a glass-ceramic article conforming to the invention, as well as to some of its advantageous embodiments, has all the advantages mentioned above.

### LIST OF REFERENCES

### Patent Literature

JP 2007170754 NIPPON ELECTRIC GLASS CO [JP] Jul. 5, 2007.
WO 2013/190230 A1 EUROKERA [EN] Dec. 27, 2013.
WO 2011/137144 A1 CORNING INC [US] Nov. 3, 2011.
WO 2014/070869 A1 CORNING INC [US] Sep. 9, 2013.
WO 2016/138051 A1 CORNING INC [US] Sep. 1, 2016.
WO 2018/093844 A1 CORNING INC [US] May 24, 2018
WO 2021/121846 A1 EUROKERA [FR] Jun. 24, 2021.
EP 0 437 228 A1 CORNING FRANCE [FR] Jul. 17, 1991
WO 2012/156444 A1 EUROKERA [EN] Nov. 22, 2012.

### Non-Patent Literature

Product specification—Surface finish: Profile method—Surface finish terms, definitions and parameters, International Standard ISO 4287:1997.
Glass in building—Determination of luminous and solar characteristics of glazing, European standard EN 410:1998.
Colorimetry—Part: CIE 1976 L*a*b* Color space, International Standard ISO/CIE 11664-4:2019.
Determination of specular gloss of non-metallic paint films at 20°, 60° and 85°, European Standard ISO 2813:1999.
Plastics—Determination of haze for transparent materials, International Standard ISO 14782:1999.

1. A planar glass-ceramic article for a cooking device, the planar glass-ceramic article comprising a first main surface, a second main surface and an edge, wherein all or part of at least one of the first and second main surfaces has an intrinsic texture whose hybrid root-mean-square roughness Rdq is between 4.4° and 11°.

2. The glass-ceramic article according to claim 1, wherein the hybrid root-mean-square roughness Rdq is between 5.5° and 9°.

3. The glass-ceramic article according to claim 1, wherein said intrinsic texture has a mean spacing roughness Rsm greater than 0.2 mm.

4. The glass-ceramic article according to claim 1, wherein the glass-ceramic article has a brightness L* less than or equal to 25.

5. The glass-ceramic article according to claim 1, wherein said intrinsic texture has a skewness, Rsk, less than −0.2.

6. The glass-ceramic article according to claim 1, wherein a 60° gloss is less than or equal to 20.

7. The glass-ceramic article according to claim 1, further comprising at least one light source for luminous display by projection or transmission onto the screen-forming work surface.

8. A method for manufacturing a glass-ceramic article, the method comprising:
a ceramization heat treatment of a glass capable of forming a glass-ceramic, and
a chemical treatment of a surface of said glass before and/or after said ceramization heat treatment,
the chemical surface treatment being carried out in such a way that, after heat treatment, the hybrid root-mean-square roughness value Rdq is between 4.4° and 11°.

9. The method according to claim 8, comprising, prior to the chemical surface treatment, a mechanical surface treatment step by sandblasting.

10. The method according to claim 8, wherein the chemical treatment is carried out before the ceramization step.

11. The method according to claim 8, wherein the chemical surface treatment is chemical etching with a hydrofluoric acid solution.

12. The method according to claim 11, wherein the hydrofluoric acid solution comprises sodium fluoride, potassium fluoride, ammonium fluoride, barium sulfate, hydrochloric acid and/or sulfuric acid, alone or in combination.

13. A cooking device comprising a glass-ceramic cooktop formed by a glass-ceramic article according to claim 1.

14. A use of a glass-ceramic article according to claim 1 as all or part of a worktop for food preparation.

15. The glass-ceramic article according to claim 3, wherein said intrinsic texture has a mean spacing roughness Rsm greater than 0.27 mm.

16. The glass-ceramic article according to claim 4, wherein the glass-ceramic article has a brightness L* less than or equal to 20.

17. The glass-ceramic article according to claim 5, wherein said intrinsic texture has a skewness, Rsk, less than −0.3.

18. The glass-ceramic article according to claim 17, wherein said intrinsic texture has a skewness, Rsk, less than −0.5.

19. The glass-ceramic article according to claim 6, wherein the 60° gloss is less than or equal to 10.

20. The method according to claim 8, wherein the hybrid root-mean-square roughness value Rdq is between 5.5° and 9°.
